(19) United States
(12) Patent Application Publication
(10) Pub. No.: US 2018/0067608 A1
(43) Pub. Date: Mar. 8, 2018

(54) STYLUS PEN, TOUCH SENSOR, AND DRIVING METHOD OF TOUCH SENSOR

(71) Applicant: Samsung Display Co., Ltd., Yongin-si (KR)

(72) Inventors: Sang Hyun LIM, Yongin-si (KR); Chang Sub JUNG, Yongin-si (KR); A Ra JO, Yongin-si (KR); Jae Woo CHOI, Yongin-si (KR)

(21) Appl. No.: 15/696,510

(22) Filed: Sep. 6, 2017

(30) Foreign Application Priority Data
Sep. 6, 2016 (KR) 10-2016-0114609

(51) Int. Cl. G06F 3/041; G06F 3/0354; G06F 3/044

(52) U.S. Cl. CPC G06F 3/0416; G06F 3/044; G06F 3/03545

(57) ABSTRACT

A stylus pen includes: a conductor; a housing surrounding at least one portion of the conductor, the housing having an insulating property; a pen tip disposed at one end of the housing, the pen tip having conductivity; and a contact member in contact with at least one of the conductor and the pen tip, wherein the conductor and the pen tip are electrically shorted or opened by the contact member.

### RELATED APPLICATIONS

The present application claims priority to Korean Patent Application No. 10-2016-0114609, filed on Sep. 6, 2016, in the Korean Intellectual Property Office, the entire disclosure of which is incorporated by reference herein.

### BACKGROUND

### 1. Field

An aspect of the present disclosure relates to a stylus pen, a touch sensor, and a driving method of the touch sensor.

### 2. Description of the Related Art

Electronic devices equipped with touch panels to detect a touch position are being widely used. In particular, as mobile electronic devices such as smart phones and tablet computers are widely spread, touch sensors are being widely used.

Recently, a demand for a technique of allowing a touch panel to recognize a touch using another tool such as a stylus pen instead of a finger has increased. A stylus pens may be classified into an active type stylus pen and a passive type stylus pen. The passive type stylus pen has a disadvantage in that it is difficult to allow another function except detecting a touch with a touch panel. The active type stylus pen has a disadvantage in that its cost is expensive due to its complicated structure.

### SUMMARY

Embodiments provide a stylus pen that has a simple structure and inexpensive unit cost, and allows a touch sensor to recognize an operation in which an external force is applied to a button or pen tip of the stylus pen, releasing of the operation in which the external force is applied to the button or pen tip of the stylus pen, and a click operation of the button or pen tip of the stylus pen.

Embodiments also provide a touch sensor that recognizes an operation in which an external force is applied to a button or pen tip of a stylus pen, releasing of the operation in which the external force is applied to the button or pen tip of the stylus pen, and a click operation of the button or pen tip of the stylus pen, and a driving method of the touch sensor.

According to an aspect of the present disclosure, there is provided a stylus pen including: a conductor; a housing surrounding at least one portion of the conductor, the housing having an insulating property; a pen tip disposed at one end of the housing, the pen tip being conductive; and a contact member in contact with at least one of the conductor and the pen tip, wherein the contact member is configured to electrically short or open the conductor and the pen tip.

The conductor may include a first terminal that faces the pen tip. The pen tip may include a second terminal that faces the conductor. The contact member may include a switch disposed between the conductor and the pen tip.

The pen tip may further include a third terminal that faces the conductor.

The switch may include: a connection conductor connected to the first terminal; a button configured to move at least one portion of the connection conductor when an external force is applied thereto; and an elastic member disposed between the connection conductor and the housing. The connection conductor may be disposed between the button and the elastic member. The connection conductor is configured to electrically short conductor and the pen tip may when the connection conductor is in contact with the second terminal or the third terminal, wherein the connection conductor is configured to electrically open the conductor and the pen tip when the connection conductor is not in contact with the second terminal and the third terminal. The connection conductor may be configured to be in contact with the second terminal when the external force is not applied to the button for a preset time or more.

The conductor may include a body and a first terminal connected to the body, the first terminal facing the pen tip. The pen tip may be connected to the housing to be movable in the housing. The pen tip may include a second terminal that faces the conductor. The contact member may include an elastic member in contact with the pen tip, the elastic member surrounding at least one portion of the pen tip.

The first terminal may include: a first extension part extending in a direction toward the pen tip from the body; and a first contact part connected to the first extension part to be bent from the first extension part. The second terminal may include: a second extension part extending in a direction toward the conductor from the pen tip; and a second contact part connected to the second extension part to be bent from the second extension part.

The first terminal may further include: a third contact part connected to the first extension part to be bent from the first extension part; and a third extension part connecting the third contact part and the body to each other therethrough, the third extension part extending in a direction toward the pen tip from the conductor. The first extension part may connect the third contact part and the first contact part to each other therethrough. The second part is configured to electrically short the conductor and the pen tip when the second contact part is in contact with the first contact part or the third contact part. The second part is configured to electrically open the conductor and the pen tip when the second contact part is not in contact with the first contact part and the third contact part. The second contact part may be configured to be in contact with the second contact part when an external force is not applied to the pen tip for a preset time or more.

According to another aspect of the present disclosure, there is provided a touch sensor including: a touch panel including a substrate and electrodes including electrodes arranged on a substrate; and a touch panel driver configured to determine at least one of whether a stylus pen has been touched on the touch panel, a position in the touch panel on which the stylus pen is touched, and whether at least one of input operations of the stylus pens has been performed or released, the touch panel driver configured to transmit touch information signal including a determined result to the outside, wherein the touch panel driver is configured to determine that a first input operation among the input operations has been performed during the second period when the stylus pen is touched at a specific position in the touch panel during a first period, is not touched at the specific position during a second period after the first period, and is touched at the specific position during a third period after the second period, and a duration of the second period is within a first preset range.

The electrodes may include: driving electrodes configured to receive a driving signal from the touch panel driver; and sensing electrodes configured to transmit a sensing signal to the touch panel driver. The touch panel driver may include: a driving signal generator configured to generate the driving signal; an interface configured to receive the sensing signal; an analog-digital converter configured to convert the signal received by the interface into a digital signal; and a digital signal processor configured to determine, based on the digital signal, at least one of whether the stylus pen has been touched on the touch panel, a position in the touch panel on which the stylus pen is touched, and whether an external force has been applied to the stylus pen.

The touch panel driver may be configured to determine that a second operation among the input operations of the stylus pen has been performed during the second period and the fourth period when the specific position is not touched during a fourth period after the third period and is touched during a fifth period after the fourth period, a duration of the third period is within a second preset range different from the first preset range, and a duration of the fourth period is included in the first preset range.

The first input operation may be an operation of applying an external force to a button of the stylus pen or an operation of applying an external force to a pen tip of the stylus. The second input operation may be an operation of clicking the button or an operation of clicking the pen tip.

The touch panel driver may be configured to determine that the first input operation of the stylus pen has been released during the fourth period When the specific position is not touched during a fourth period after the third period and is touched during a fifth period after the fourth period, a duration period of the third period is not within the second preset range, and a duration of the fourth period is within the first preset range.

According to still another aspect of the present disclosure, there is provided a method for driving a touch sensor, the method including: when a stylus pen is touched on a touch panel, sensing a position in the touch panel on which the stylus pen is touched until the touch is stopped; calculating a period in which the touch is stopped; and when the period in which the touch is stopped is within a first preset range, determining that a first input operation of the stylus pen has been performed.

In the determining that the first input operation of the stylus pen has been performed, the touched position until the touch may be again stopped.

The method may further include, after the determining that the first input operation of the stylus pen has been performed, calculating a period in which the touch is again stopped.

In the calculating of the period in which the touch is again stopped, a period in which the touch is stopped and then is again stopped may be further calculated. The method may further include, when the period in which the touch is again stopped is within the first preset range, and the period in which the touch is stopped and then is again stopped is within a second preset range different from the first preset range, determining that a second input operation of the stylus pen has been performed.

The first input operation may be an operation of applying an external force to a button of the stylus pen or an operation of applying an external force to a pen tip of the stylus. The second input operation may be an operation of clicking the button or an operation of clicking the pen tip.

In the calculating of the period in which the touch is again stopped, a period in which the touch is stopped and then is again stopped may be further calculated. The method may further include, when the period in which the touch is again stopped is within the first preset range, and the period in which the touch is stopped and then is again stopped is not within the second preset range different from the first preset range, determining that the first input operation of the stylus pen has been released.

The method may further include, when the period in which the touch is again stopped is not within the first preset range, determining that the stylus pen has been spaced apart from the touch panel.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIGS. 1, 2, 3, and 4 are views illustrating stylus pens according to embodiments of the present disclosure.

FIGS. 5A, 5B, and 5C are views illustrating states of the stylus pen of FIG. 2.

FIGS. 6A, 6B, and 6C are views illustrating states of the stylus pen of FIG. 4.

FIG. 7 is a view illustrating a touch sensor according to an embodiment of the present disclosure.

FIG. 8 is a view illustrating an interaction between the stylus pen of FIG. 2 and the touch sensor of FIG. 7.

FIG. 9 is a view illustrating an interaction between the stylus pen of FIG. 4 and the touch sensor of FIG. 7.

FIG. 10 is a waveform diagram illustrating an operation of the touch sensor of FIG. 7 when the stylus pen of FIG. 2 or 4 is touched on the touch sensor.

FIG. 11 is a flowchart illustrating a driving method of the touch sensor according to an embodiment of the present disclosure.

### DETAILED DESCRIPTION

Hereinafter, exemplary embodiments of the present disclosure will be described in detail with reference to the accompanying drawings. Like reference numerals indicate like elements throughout the specification and drawings. In the following description, detailed explanation of known related functions and constitutions may be omitted to avoid unnecessarily obscuring the subject manner of the present disclosure. Names of elements used in the following description are selected in consideration of facility of specification preparation. Thus, the names of the elements may be different from names of elements used in a real product.

It will be further understood that the terms “includes” and/or “including”, when used in this specification, specify the presence of stated features, integers, steps, operations, elements, and/or components, but do not preclude the presence and/or addition of one or more other features, integers, steps, operations, elements, components, and/or groups thereof. Further, an expression that an element such as a layer, region, substrate or plate is placed “on” or “above” another element indicates not only a case where the element is placed “directly on” or “just above” the other element but also a case where a further element is interposed between the element and the other element. On the contrary, an expression that an element such as a layer, region, substrate or plate is placed “beneath” or “below” another element indicates not only a case where the element is placed “directly beneath” or “just below” the other element but also a case where a further element is interposed between the element and the other element.

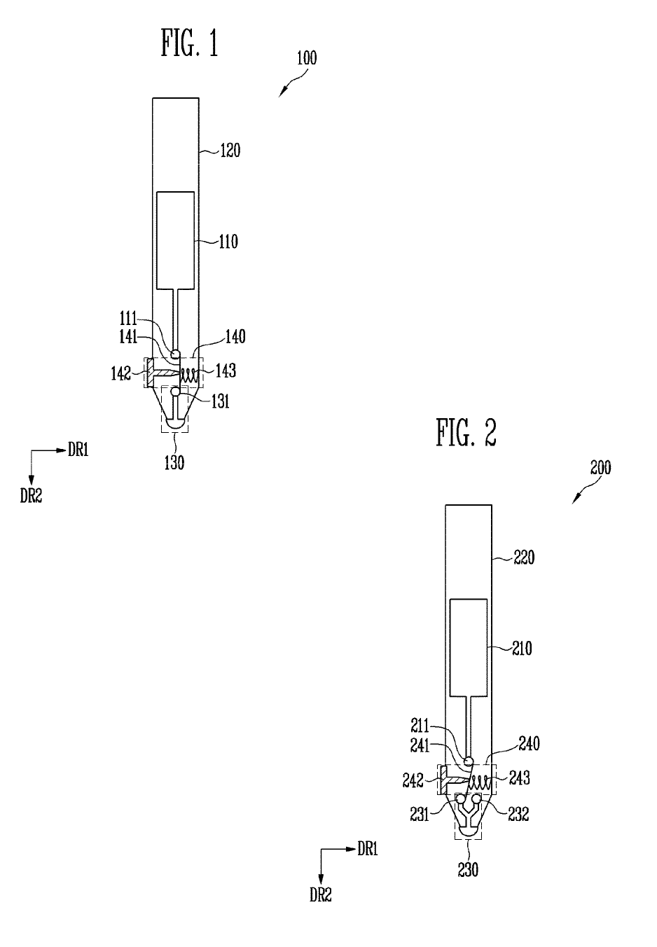

FIGS. 1, 2, 3, and 4 are views illustrating stylus pens according to embodiments of the present disclosure.

Referring to FIG. 1, a stylus pen 100 includes a conductor 110, a housing 120, a pen tip 130, and a switch 140.

The conductor 110 may include a metal. The metal may include at least one of aluminum, gold, nickel, titanium, platinum, chromium, copper, etc., and any alloy thereof. The material, volume, and shape of the conductor 110 may be designed to have influence on the quantity of electric charges flowing in a touch panel when the conductor 110 is touched in a certain region of the touch panel. For example, the conductor 110 may substantially affect the quantity of electric charges flowing in the touch panel even when the conductor 110 is touched in a certain region of the touch panel. Here, the touch may include physical contact and/or physical hovering of the conductor 110. The conductor 110 includes a first terminal 111.

The housing 120 may surround the conductor 110 and have an insulating property. The housing 120 may include at least one of plastic, rubber, and wood. One end or side surface of the housing 120 may have a hole.

The pen tip 130 is conductive and is disposed at one end of the housing 120. In some embodiments, the pen tip 130 may be disposed in the hole provided at the one end of the housing 120. The pen tip 130 includes a second terminal 131 facing the conductor 110, and the first terminal 111 faces the pen tip 130. The pen tip 130 may include at least one of the materials mentioned as a material that may be included in the conductor 110. The material, volume, and shape of the pen tip 130 may be designed not to have influence on the quantity of electric charges flowing in a touch panel even when the pen tip 130 is independently touched on the touch panel. For example, the pen tip 130 may not substantially affect the quantity of electric charges flowing in the touch panel even when the pen tip 130 is independently touched on the touch panel.

The switch 140 includes a connection conductor 141, a button 142, and an elastic member 143. The conductor 110 and the pen tip 130 are electrically opened or shorted by the switch 140.

One end of the connection conductor 141 is connected to the first terminal 111, and whether the other end of the connection conductor 141 is in contact with the second terminal 131 is determined by the button 142 and the elastic member 143. When the other end of the connection conductor 141 is in contact with the second terminal 131, the conductor 110 and the pen tip 130 are electrically shorted. When the other end of the connection conductor 141 is not in contact with the second terminal 131, the conductor 110 and the pen tip 130 are electrically opened.

The button 142 may be disposed in the hole provided at the side surface of the housing 120. When an external force is applied to the button 141, the button 142 moves the connection conductor 141. For example, when a user presses the button 142, an external force in a first direction DR1 may be applied to the button 142, and the button 142 may move the connection conductor 141 in the first direction DR1.

The elastic member 143 may include a spring. One end of the spring may be in contact with the housing 120, and the other end of the spring may be in contact with the connection conductor 141. The connection conductor 141 is disposed between the button 142 and the elastic member 143. When the external force in the first direction DR1 is applied to the button 142, the elastic member 143 applies, to the connection conductor 141, an elastic force in a direction opposite to the first direction DR1.

When the external force is not applied to the button 142 for a preset time (e.g., 1 second) or more, the other end of the connection conductor 141 is in contact with the second terminal 131 by the elastic force of the elastic member 143. When the preset time elapses in a state in which the user does not press the button 142, the other end of the connection conductor 141 is in contact with the second terminal 131, and therefore, the conductor 110 and the pen tip 130 are electrically shorted. When the external force in the first direction DR1 is applied to the button 142, the other end of the connection conductor 141 is moved in the first direction DR1. As the other end of the connection conductor 141 is not in contact with the second terminal 131, the conductor 110 and the pen tip 130 are electrically opened.

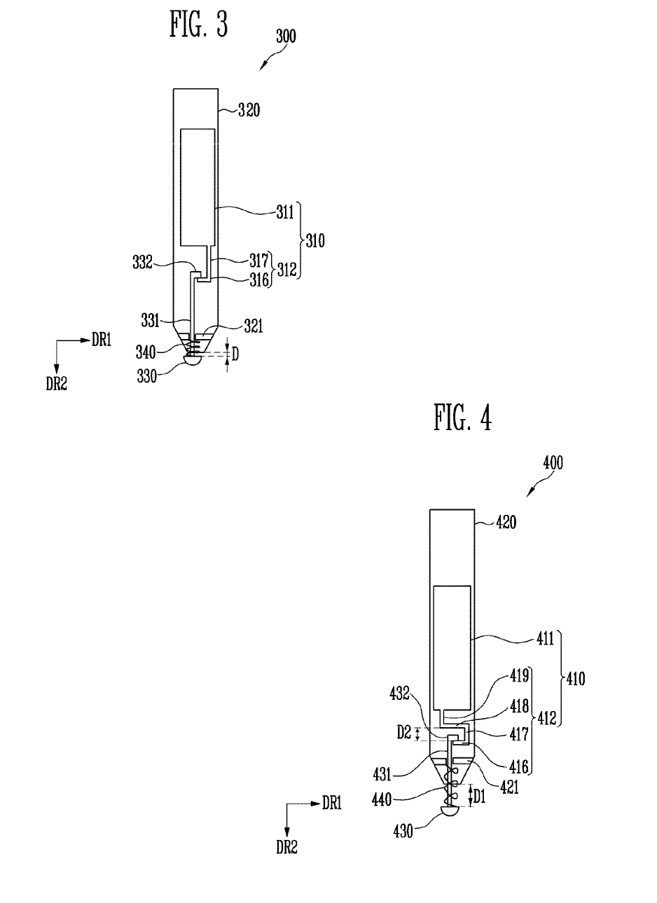

Referring to FIG. 2, a stylus pen 200 includes a conductor 210, a housing 220, a pen tip 230, and a switch 240.

The conductor 210 and the housing 220 are the substantially the same as the conductor 110 and the housing 220, respectively, and therefore, their detailed descriptions may be omitted.

The pen tip 230 includes a second terminal 231 and a third terminal 232. The second terminal 231 and the third terminal 232 face the conductor 210.

The switch 240 includes a connection conductor 241, a button 242, and an elastic member 243. The conductor 210 and the pen tip 230 are electrically shorted or opened by the switch 240.

One end of the connection conductor 241 is connected to a first terminal 211, and whether the other end of the connection conductor 241 is in contact with the second terminal 231 or the third terminal 232, as determined by the button 242 and the elastic member 243. When the other end of the connection conductor 241 is in contact with the second terminal 231 or the third terminal 232, the conductor 210 and the pen tip 230 are electrically shorted. When the other end of the connection conductor 241 is not in contact with the second terminal 231 or the third terminal 232, the conductor 210 and the pen tip 230 are electrically opened.

The button 242 and the elastic member 243 are the substantially same as the button 142 and the elastic member 143, respectively, and therefore, their detailed descriptions may be omitted.

When an external force from a user is applied to the button 242, the conductor 210 and the pen tip 230 are electrically opened for a certain time and then electrically shorted. In addition, when an external force in a first direction DR1, which has been applied to the button 242, is stopped, the conductor 210 and the pen tip 230 are electrically opened for a certain time and then electrically shorted.

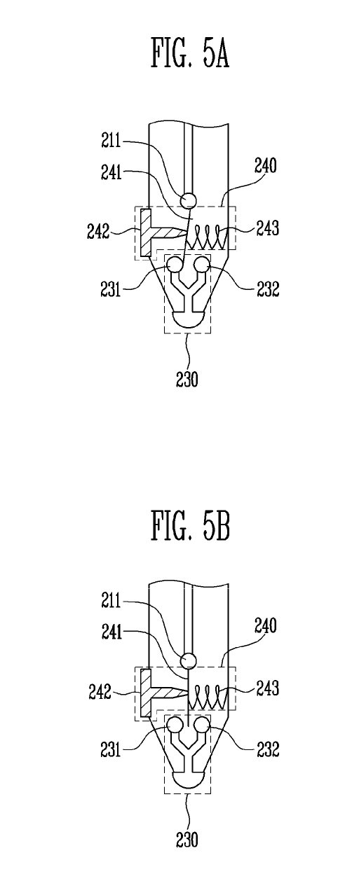

Specific contact states of the stylus pen 200 shown in FIG. 2 will be described in detail later with reference to FIGS. 5A, 5B, and 5C.

Referring to FIG. 3, a stylus pen 300 includes a conductor 310, a housing 320, a pen tip 330, and an elastic member 340.

The conductor 310 may include at least one of the materials mentioned as a material that may be included in the conductor 110. The material, volume, and shape of the conductor 310 may be designed to have influence on the quantity of electric charges flowing in a touch panel when the conductor 310 is touched in a certain region of the touch panel. The conductor 310 includes a body 311 and a first terminal 312, and the first terminal 312 includes a first extension part 317 and a first contact part 316.

The first extension part 317 extends in a second direction DR2. The second direction DR2 may be defined as a direction toward the pen tip 330 from the conductor 310, and the first contact part 316 is connected to the first extension part 317 to be bent from the first extension part 317.

The housing 320 may surround the conductor 310 and have an insulating property. The housing 320 may include at least one of plastic, rubber, and wood. One end of the housing 320 may have a hole. Also, the housing 320 may have a guide 321.

The pen tip 330 is conductive and is connected to the housing 320 to be movable in the housing 320. The pen tip 330 may be disposed in the hole provided at the one end of the housing 320. The pen tip 330 may be moved by a distance D with respect to the housing 320. For example, the pen tip 330 may be disposed to be a distance D with respect to the housing 320 when pressure is not applied to the pen tip 330. The moving direction of the pen tip 330 may be limited to the second direction DR2 or a direction opposite to the second direction DR2 by the guide 321. In some embodiments, at least one portion of the pen tip 330 may be disposed in the hole provided at the one end of the housing 320. The pen tip 330 includes a second terminal including a second extension part 331 and a second contact part 332.

The elastic member 340 is disposed to surround at least one portion of the pen tip 330. The elastic member 340 may include a spring. One end of the elastic member 340 may be in contact with the guide 321, and the other end of the elastic member 340 may be in contact with the pen tip 330. The elastic member 340 allows the conductor 310 and the pen tip 330 to be electrically opened or shorted.

When the first contact part 316 of the conductor 310 is in contact with the second contact part 332 of the pen tip 330, the conductor 310 and the pen tip 330 are electrically shorted. When the first contact part 316 is not in contact with the second contact part 332, the conductor 310 and the pen tip 330 are electrically opened. Whether the first contact part 316 is in contact with the second contact part 332 is determined by the pen tip 330 and the elastic member 340.

An external force from a user may be applied to the pen tip 330, and the direction of the external force may be the direction opposite to the second direction DR2. Here the external force applied in the direction opposite to the second direction DR2 may be defined as a writing pressure. When the external force is not applied to the pen tip 330 for a preset time or more, the second contact part 332 is in contact with the first contact part 316 by an elastic force of the elastic member 340, and the conductor 310 and the pen tip 330 are electrically shorted. When the external force in the direction opposite to the second direction DR2 is applied to the pen tip 330, the other end of the pen tip 330 may be moved in the direction opposite to the second direction DR2 by the external force, the second contact part 332 is not in contact with the first contact part 316, and the conductor 310 and the pen tip 330 are electrically opened.

Referring to FIG. 4, a stylus pen 400 includes a conductor 410, a housing 420, a pen tip 430, and the elastic member 440.

The housing 420 and the elastic member 440 are the substantially same as the housing 320 and the elastic member 340, respectively, and therefore, their detailed descriptions may be omitted.

The pen tip 430 may be conductive and be connected to the housing 420 to be movable in the housing 420. The pen tip 430 includes a second terminal including a second extension part 431 and a second contact part 432.

The second extension part 431 may extend in a second direction DR2, and the second contact part 432 is connected to the second extension part 431 to be bent from the second extension part 431.

The conductor 410 includes a body 411 and a first terminal 412. The first terminal 412 includes a first extension part 417, a first contact part 416, a third contact part 418, and a third extension part 419.

The first extension part 417 and the first contact part 416 are substantially same the first extension part 317 and the first contact part 316, respectively, and therefore, their detailed descriptions may be omitted.

The third contact part 418 is connected to the first extension part 417 to be bent from the first extension part 417. Here, a second distance D2 between the contact part 416 and the third contact part 418 may be shorter than a first distance D1 by which the pen tip 430 is movable with respect to the housing 420.

The third extension part 419 allows the third contact part 418 and the body 411 to be connected to each other therethrough, and extends in the second direction DR2.

When an external force from a user is applied to the pen tip 430, the conductor 410 and the pen tip 430 are electrically opened for a certain time and then electrically shorted. In addition, when the external force that has been applied to the pen tip 430 is stopped, the conductor 410 and the pen tip 430 are electrically opened for a certain time and then electrically shorted.

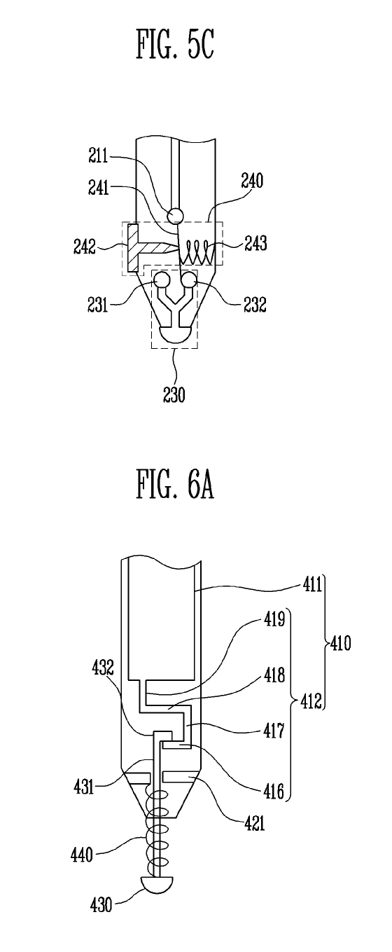

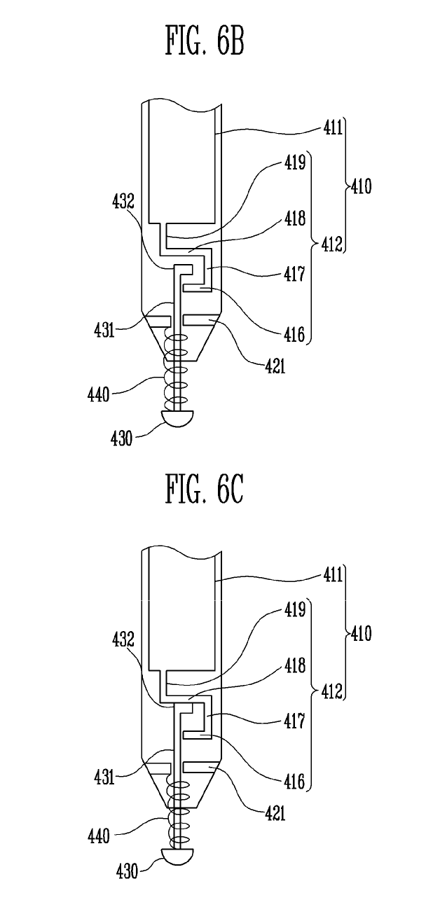

States of the stylus pen 400 of FIG. 4 will be described in detail later with reference to FIGS. 6A, 6B, and 6C.

FIGS. 5A, 5B, and 5C are views illustrating states of the stylus pen of FIG. 2.

FIG. 5A is a view illustrating a state of the stylus pen when the other end of the connection conductor is in contact with the second terminal. When an external force is not applied to the button 242 for a preset time or more, the other end of the connection conductor 241 is in contact with the second terminal 231 by an elastic force of the elastic member 243. As the other end of the connection conductor 241 is in contact with the second terminal 231, the conductor 210 and the pen tip 230 are electrically shorted.

FIG. 5B is a view illustrating a state of the stylus pen when the other end of the connection conductor is disposed between the first terminal and the second terminal. As the connection conductor 241 is not in contact with the second terminal 231 and the third terminal 232, the conductor 210 and the pen tip 230 are electrically opened.

While the other end of the connection conductor 241 is being moved toward the third terminal 232 from the second terminal 231 or while the other end of the connection conductor 241 is being moved toward the second terminal 231 from the third terminal 232, the conductor 210 and the pen tip 230 may be electrically opened as shown in FIG. 5B.

FIG. 5C is a view illustrating a state of the stylus pen when the other end of the connection conductor is in contact with the third terminal. The other end of the connection conductor 241 may be in contact with the third terminal 232 by an external force. Since the other end of the connection conductor 241 is in contact with the third terminal 232, and the conductor 210 and the pen tip 230 are electrically shorted.

FIGS. 6A, 6B, and 6C are views illustrating states of the stylus pen of FIG. 4.

FIG. 6A is a view illustrating a state of the stylus pen when the second contact part is in contact with the first contact part. When an external force is not applied to the pen tip 430 for a preset time, the second contact part 432 is in contact with the first contact part 416 by an elastic force of the elastic member 430. As the second contact part 432 is in contact with the first contact part 416, the conductor 410 and the pen tip 430 are electrically shorted.

FIG. 6B is a view illustrating a state of the stylus pen when the second contact part is disposed between the first contact part and the third contact part. As the second contact part 432 is not in contact with the first contact part 416 and the third contact part 418, the conductor 410 and the pen tip 430 are electrically opened.

While the second contact part 432 is being moved toward the third contact part 418 from the first contact part 416 or while the second contact part 432 is being moved toward the first contact part 416 from the third contact part 418, the conductor 410 and the pen tip 430 may be electrically opened as shown in FIG. 6B.

FIG. 6C is a view illustrating a state of the stylus pen when the second contact part is in contact with the third contact part. The second contact part 432 may be in contact with the third contact part 418 by the external force. Since the second contact part 432 is in contact with the third contact part 418, the conductor 410 and the pen tip 430 are electrically shorted.

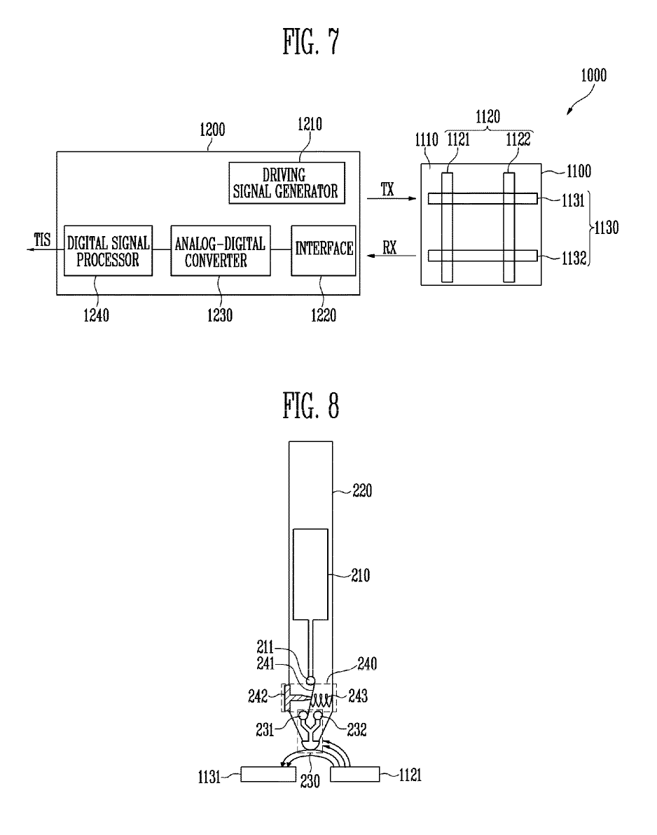

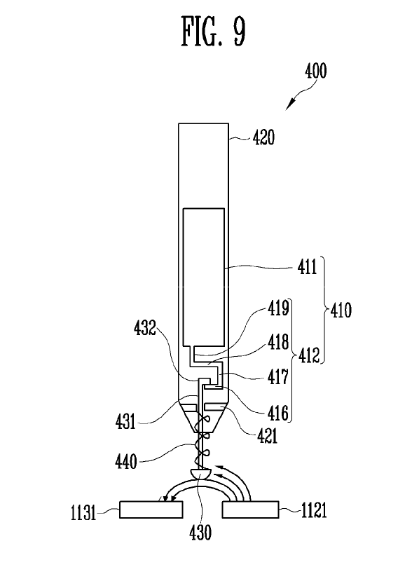

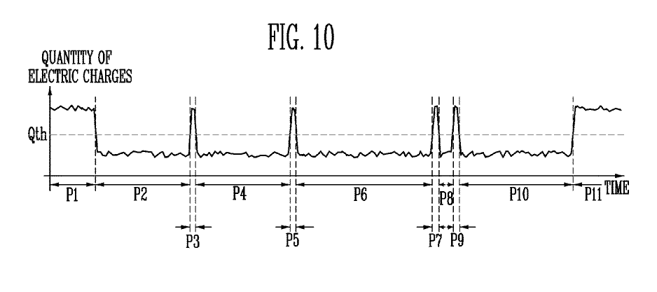

FIG. 7 is a view illustrating a touch sensor according to an embodiment of the present disclosure. FIG. 8 is a view illustrating an interaction between the stylus pen of FIG. 2 and the touch sensor of FIG. 7. FIG. 9 is a view illustrating an interaction between the stylus pen of FIG. 4 and the touch sensor of FIG. 7.

Referring to FIG. 7, the touch sensor 1000 includes a touch panel 1100 and a touch panel driver 1200.

The touch panel 1100 includes a substrate 1110 and electrodes 1120 and 1130.

The substrate 1110 may include a material that enables light to be transmitted therethrough. In some embodiments, the substrate 1110 may have an insulating property.

The electrodes 1120 and 1130 are arranged on the substrate 1110, and include driving electrodes 1120 and sensing electrodes 1130.

The driving electrodes 1120 include a first driving electrode 1121 and a second driving electrode 1122. The first driving electrode 1121 and the second driving electrode 1122 may be arranged in parallel to each other. A driving signal Tx may be supplied to the driving electrodes 1120.

The sensing electrodes 1130 include a first sensing electrode 1131 and a second sensing electrode 1132. The first sensing electrode 1131 and the second sensing electrode 1132 may be arranged in parallel to each other. Each of the sensing electrodes 1131 and 1132 may be disposed to intersect the driving electrodes 1120. The sensing electrodes 1130 may transmit a sensing signal Rx.

The touch panel driver 1200 includes a driving signal generator 1210, an interface 1220, an analog-digital converter 1230, and a digital signal processor 1240.

The driving signal generator 1210 generates a driving signal Tx and supplies the driving signal Tx to the driving electrodes 1120.

The interface 1220 receives a sensing signal Rx and transmits the sensing signal Rx to the analog-digital converter 1230.

The analog-digital converter 1230 converts the sensing signal Rx into a digital signal and transmits the converted digital signal to the digital signal processor 1240.

The digital signal processor 1240 determines, based on the digital signal, at least one of whether the stylus pen 200 or 400 has been touched on the touch panel 1100, a position in the touch panel 1100 on which the stylus pen 200 or 400 has been touched, and whether at least one of input operations of the stylus pen 200 or 400 has been performed or released. In some embodiments, the digital signal processor 1240 may calculate a quantity of electric charges from each of the sensing electrodes 1131 and 1132, and determine whether the quantity of electric charges is equal to or less than a preset value. A specific function may be a function different from that of determining the presence of a touch. The specific function will be described in detail later. The digital signal processor 1240 generates a touch information signal TIS based on a determined result, and transmits the touch information signal TIS to the outside.

Referring to FIG. 8, since the other end of the connection conductor 241 is in contact with the second terminal 231, the conductor 210 and the pen tip 230 are electrically shorted. For convenience of description, it may be assumed that the stylus pen 200 has been touched in the vicinity of a portion at which the first driving electrode 1121 and the first sensing electrode 1131 intersect each other in the touch panel 1100.

Since some of electric charges flowing from the first driving electrode 1121 to the first sensing electrode 1131 flows toward the conductor 210, the quantity of electric charges flowing from the first driving electrode 1121 to the first sensing electrode 1131 is decreased. The digital signal processor 1240 may sense a change in quantity of electric charges flowing from the first driving electrode 1121 to the first sensing electrode 1131, and determine that the stylus pen 200 has been touched in the vicinity of the portion at which the first driving electrode 1121 and the first sensing electrode 1131 intersect each other.

However, when the connection conductor 241 is disposed between the second terminal 231 and the third terminal 232 as shown in FIG. 5B, the conductor 210 and the pen tip 230 are electrically opened. Some of the electric charges flowing into the first sensing electrode 1131 flow toward the pen tip 230 but do not flow into the conductor 210. Since the pen tip 230 is designed not to have large influence on the quantity of electric charges flowing in the touch panel 1100 even when the pen tip 230 is touched in a certain region of the touch panel 100, the digital signal processor 1240 cannot sense a change in quantity of electric charges flowing from the first driving electrode 1121 to the first sensing electrode 1131, or senses only a small change. Thus, the digital signal processor 1240 may determine that the stylus pen 200 has not been touched on the touch panel 1100.

Referring to FIG. 9, since the second contact part 432 is in contact with the first contact part 416, the conductor 410 and the pen tip 430 are electrically shorted. For convenience of description, it may be assumed that the stylus pen 400 has been touched in the vicinity of a portion at which the first driving electrode 1121 and the first sensing electrode 1131 intersect each other in the touch panel 1100.

As described with reference to FIG. 8, when the conductor 410 and the pen tip 430 are electrically shorted, the digital signal processor 1240 may sense a change in quantity of electric charges flowing from the first driving electrode 1121 to the first sensing electrode 1131, and determine that the stylus pen 400 has been touched in the vicinity of the portion at which the first driving electrode 1121 and the first sensing electrode 1131 intersect each other. When the conductor 410 and the pen tip 430 are electrically opened, the digital signal processor 1240 may sense a change in quantity of electric charges flowing from the first driving electrode 1121 to the first sensing electrode 1131, and determine that the stylus pen 400 has not been touched on the touch panel 1100.

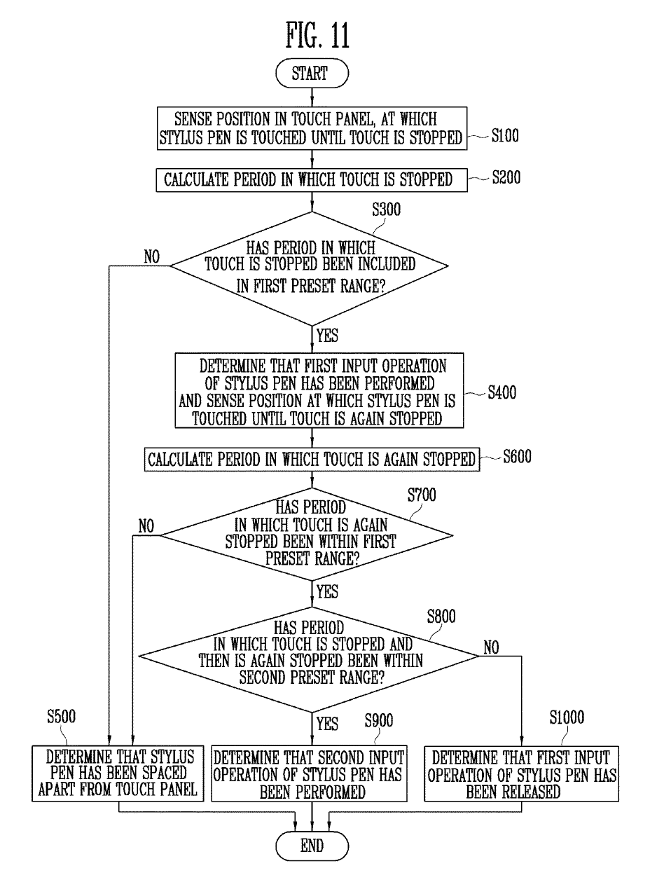

FIG. 10 is a waveform diagram illustrating an operation of the touch sensor of FIG. 7 when the stylus pen of FIG. 2 or 4 is touched on the touch sensor. For convenience of description, FIGS. 2, 4, 5A, 5B, 5C, 6A, 6B, 6C, 8, and 9 will be additionally referred to. In addition, for convenience of description, it may be assumed that the stylus pen 200 or 400 is touched only in the vicinity of a portion at which the first driving electrode 1121 and the first sensing electrode 1131 intersect each other in the touch panel 1100, or that the stylus pen 200 or 400 is not touched on the touch panel 1100.

In a first period P1, the stylus pen 200 or 400 is not touched on the touch panel 1100. The quantity of electric charges flowing from the first driving electrode 1121 to the first sensing electrode 1131 in the sensing signal RX is larger than a preset quantity Qth of electric charges. The digital signal processor 1240 determines that the stylus pen 200 or 400 has not been touched on the touch panel 1100.

When a user touches the portion at which the first driving electrode 1121 and the first sensing electrode 1131 intersect each other without pressing the button 242 of the stylus pen 200, the other end of the connection conductor 241 is in contact with the second terminal 231, so that the pen tip 230 and the conductor 210 are electrically shorted (see FIG. 5A). Some of electric charges flowing from the first driving electrode 1121 to the first sensing electrode 1131 flow toward the conductor 210, and the quantity of electric charges flowing into the conductor 210 is sufficiently large. As the stylus pen 200 is touched on the touch panel 1100, the first period P1 is ended, and a second period P2 is started. The case where the stylus pen 400 is touched at the portion at which the first driving electrode 1121 and the first sensing electrode 1131 intersect each other in a state in which an external force is not applied to the stylus pen 400 (see FIG. 6A) may correspond to the case where the user touches the portion at which the first driving electrode 1121 and the first sensing electrode 1131 intersect each other without pressing the button 242 of the stylus pen 200.

During the second period P2, the quantity of electric charges flowing from the first driving electrode 1121 to the first sensing electrode 1131 has a value smaller than that of the preset quantity Qth of electric charges. The digital signal processor 1240 determines that the stylus pen 200 or 400 has been touched at the portion at which the first driving electrode 1121 and the first sensing electrode 1131 intersect each other in the touch panel 1100 during the second period P2.

When a first input operation (e.g., an operation of applying an external force to the button 242 of the stylus pen 200 or an operation of applying an external force to the pen tip 430 of the stylus pen 400) among input operations of the stylus pen 200 or 400 is performed, the second period P2 is ended, and a third period P3 is started. By the first input operation of the stylus pen 200, the other end of the connection conductor 241 is moved from the second terminal 231 to the third terminal 232. While the other end of the connection conductor 241 is being moved from the second terminal 231 to the third terminal 232, the connection conductor 241 is not in contact with the second terminal 231 and the third terminal 232, and therefore, the pen tip 230 and the conductor 210 are electrically opened (see FIG. 5B). Some of electric charges flowing from the first driving electrode 1121 to the first sensing electrode 1131 flow toward the pen tip 230, and the quantity of electric charges flowing into the pen tip 230 is not sufficiently large. The quantity of electric charges flowing from the first driving electrode 1121 to the first sensing electrode 1131 has a value larger than that of the preset quantity Qth of electric charges.

The case where the second contact part 432 is moved from the first contact part 416 to the third contact part 418 by the first input operation of the stylus pen 400 (see FIG. 6B) may correspond to the case whether the other end of the connection conductor 241 is moved from the second terminal 231 to the third terminal 232 (see FIG. 5B).

During the third period P3, the quantity of electric charges flowing from the first driving electrode 1121 to the first sensing electrode 1131 has a value larger than that of the preset quantity Qth of electric charges. The digital signal processor 1240 calculates a duration of the third period P3, and compares the duration of the third period P3 with a first preset range.

When the third period P3 is started due to the first input operation of the stylus pen 200 or 400, the duration of the third period P3 may be within the first preset range.

When the stylus pen 200 is spaced apart from the touch panel 1100 and then is again in contact with the touch panel 1100, the third period P3 is ended, and a fourth period P4 is started. However, the duration of the third period P3 may be larger than the upper limit of the first preset range. When the duration of the third period P3 exceeds the upper limit of the first preset range, the digital signal processor 1240 may determine that the stylus pen 200 has been spaced apart from the touch panel 1100 even before the third period P3 is ended. The upper limit of the first preset range may be set to be longer than a period in which the quantity of electric charges when the first input operation of the stylus pen 200 or 400 is performed is larger than the preset quantity Qth of electric charges and to be shorter than a period in which the quantity of electric charges when the stylus pen 200 is spaced apart from the touch panel 1100 and then is again in contact with the touch panel 1100 is larger than the preset quantity Qth of electric charges.

In another scenario, it is assumed that the third period P3 has been started due to the first input operation of the stylus pen 200 or 400, and the duration of the third period P3 is within the first preset range. Since the duration of the third period P3 within the first preset range in a state in which input operations are not performed, the digital signal processor 1240 may determine that the first input operation of the stylus pen 200 or 400 has been performed during the third period P3.

The other end of the connection conductor 241 is in contact with the third terminal 232 due to the first input operation of the stylus pen 200 or 400. As the conductor 210 and the pen tip 230 are electrically shorted, the third period P3 is ended, and a fourth period P4 is started.

The case where the second contact part 432 is in contact with the third contact part 418 by an external force (see FIG. 6C) may correspond to the case where the other end of the connection conductor 241 is in contact with the third terminal 232 by an external force (see FIG. 5C).

The quantity of electric charges flowing from the first driving electrode 1121 to the first sensing electrode 1131 during the fourth period P4 has a value smaller than that of the preset quantity Qth of electric charges. The digital signal processor 1240 determines that the stylus pen 200 or 400 has been touched at the portion at which the first driving electrode 1121 and the first sensing electrode 1131 intersect each other in the touch panel 1100 during the fourth period P4.

When the first input operation of the stylus pen 200 is released, the other end of the connection conductor 241 is moved from the third terminal 232 to the second terminal 231. The other end of the connection conductor 241 is disposed between the second terminal 231 and the third terminal 232, and the conductor 210 and the pen tip 230 are electrically opened (see FIG. 5B).

It may be assumed that, as the first input operation of the stylus pen 200 is released, the quantity of electric charges flowing from the first driving electrode 1121 to the first sensing electrode 1131 has a value larger than that of the preset quantity Qth of electric charges, the fourth period P4 is ended, and a fifth period P5 is started. The digital signal processor 1240 compares a duration of the fourth period P4 with a second preset range. For convenience of description, it may be assumed that the duration of the fourth period P4 is larger than the upper limit of the second preset range.

In the fifth period P5, the digital signal processor 1240 compares a duration of the fifth period P5 with the first preset range. For convenience of description, it may be assumed that the duration of the fifth period P5 is within the first preset range. The case where the second contact part 432 is disposed between the third contact part 418 and the first contact part 416 (see FIG. 6B) may correspond to the case where the other end of the connection conductor 241 is disposed between the third terminal 232 and the second terminal 231 (see FIG. 5B).

The duration of the fourth period P4 is larger than the upper limit of the second preset range, and a duration of the fifth period P5 is within the first preset range. Therefore, the digital signal processor 1240 may determine that the first input operation of the stylus pen 200 or 400 has been released during the fifth period P5.

When the other end of the connection conductor 241 is in contact with the second terminal 231 (see FIG. 5A), the fifth period P5 is ended, and a sixth period P6 is started. The case where the second contact part 432 is in contact with the first contact part 416 (see FIG. 6A) may correspond to the case where the other end of the connection conductor 241 is in contact with the second terminal 231 (see FIG. 5A).

In the sixth period P6, similarly to the second period P2, the quantity of electric charges flowing from the first driving electrode 1121 to the first sensing electrode 1131 has a value smaller than that of the preset quantity Qth of electric charges. The digital signal processor 1240 determines that the stylus pen 200 or 400 has been touched at the portion at which the first driving electrode 1121 and the first sensing electrode 1131 intersect each other in the touch panel 1100 during the sixth period P6.

The user may press and then release the button 242, but click the button 242. That is, a second input operation among input operations of the stylus pen 200 or 400 may be an operation of clicking the button 242 or an operation of clicking the pen tip 430. In this specification, the clicking may be defined as releasing the pressing within a preset time after the pressing.

When the user presses the button 242, the other end of the connection conductor 241 is moved from the second terminal 231 to the third terminal 232. As the connection conductor 241 is not in contact with the second terminal 231 and the third terminal 232, the sixth period P6 is ended, and a seventh period P7 is started.

As the connection conductor 241 is in contact with the third terminal 232, the seventh period P7 is ended, and an eighth period P8 is started. The digital signal processor 1240 compares a duration of the seventh period P7 with the first preset range. Since it is assumed that the user has clicked the button 242, the duration of the seventh period P7 within the first preset range.

After the seventh period P7 is ended, the digital signal processor 1240 determines that the first input operation of the stylus pen 200 or 400 has been performed during the seventh period P7. In addition, since it is assumed that the user has clicked the button 242, the user presses the button 242 and then releases the pressing of the button 242 within a preset time. That is, a duration of the eighth period P8 is within the second preset range. If the user releases the pressing of the button 242, the connection conductor 241 is moved from the third terminal 232 to the second terminal 231, and therefore, the conductor 210 and the pen tip 230 are electrically opened. As the conductor 210 and the pen tip 230 are electrically opened, the eighth period P8 is ended, and a ninth period P9 is started. The upper limit of the second preset range may be set to be longer the duration of the eighth period P8 and to be shorter than the duration of the fourth period P4 due to the first input operation and the releasing thereof.

In the ninth period P9, the digital signal processor 1240 compares a duration of the ninth period P9 with the first preset range. Since it is assumed that the user has released the pressing of the button 242, the duration of the ninth period P9 is within the first preset range. As the connection conductor 241 is in contact with the second terminal 231, the ninth period P9 is ended, and a tenth period P10 is started.

Since the duration of the seventh period P7 is included in the first preset range, the duration of the ninth period P9 is within the first preset range, and the duration of the eighth period P8 is within the second preset range, the digital signal processor 1240 may determine that the second input operation of the stylus pen 200 or 400 has been performed during the seventh and ninth periods P7 and P9.

Similarly to the second period P2, the digital signal processor 1240 determines that the stylus pen 200 or 400 has been touched at the portion at which the first driving electrode 1121 and the first sensing electrode 1131 intersect each other in the touch panel 1100 during the tenth period P10. It may be assumed that, as the stylus pen 200 or 400 is spaced apart from the touch panel 1100, the tenth period P10 is ended, and an eleventh period P11 is started.

A duration of the eleventh period P11 is larger than the upper limit of the first preset range, and therefore, the digital signal processor 1240 may determine that the stylus pen 200 or 400 has been spaced apart from the touch panel 1100.

FIG. 11 is a flowchart illustrating a driving method of the touch sensor according to an embodiment of the present disclosure. For convenience of description, FIGS. 2, 4, 5A, 5B, 5C, 6A, 6B, 6C, 8, 9, and 10 will be additionally referred.

In step S100, the touch sensor 1000 senses a position in the touch panel 1100, at which the stylus pen 200 or 400 is touched. When the touch on the touch panel 1100 is stopped, step S100 is ended.

In step S200, the touch panel driver 1200 may calculate a period in which the touch on the touch panel 1100 is stopped. Referring to FIG. 10, when the second period P2, the third period P3, and the fourth period P4 are sequentially performed, the touch panel driver 1200 may calculate a duration of the third period P3. Similarly, when the fifth to eleventh periods P5 to P11 are sequentially performed, the touch panel driver 1200 may calculate durations of the fifth period P5, the seventh period P7, the ninth period P9, and the eleventh period P11.

In step S300, the touch panel driver 1200 compares the period in which the touch is stopped with the first preset range. Referring to FIG. 10, the touch is maintained during the second period P2, is stopped during the third period P3, and is again maintained during the fourth period P4. Since the period in which the touch is stopped corresponds to the duration of the third period P3, the duration of the third period P3 is compared with the first preset range in step S300. Similarly, the touch is maintained during the sixth period P6, is stopped during the seventh period P7, and is again maintained during the eighth period P8. Since the period in which the touch is stopped corresponds to the duration of the seventh period P7, the duration of the seventh period P7 is compared with the first preset range in step S300.

When the period in which the touch is stopped is included in the first preset range, step S400 is performed. When the period in which the touch is stopped is not included in the first preset range, step S500 is performed.

When the period in which the touch is stopped exceeds the upper limit of the first preset range, step S500 may be performed even when the period in which the touch is stopped is not defined. Referring to FIG. 10, the duration of the eleventh period P11 exceeds the upper limit of the first preset range, and therefore, step S500 may be performed even when the duration of the eleventh period P11 is not defined.

In step S400, the touch panel driver 1200 determines that the first input operation of the stylus pen 200 or 400 has been performed. When the third period P3 is ended and the fourth period P4 is started, the touch panel driver 1200 determines that the first input operation of the stylus pen 200 or 400 has been performed during the third period P3. In step S400, the touch panel driver 1200 senses a position at which the stylus pen 200 or 400 is touched until the touch is again stopped. In addition, the touch panel driver 1200 may determine that the first input operation of the stylus pen 200 or 400 has been performed during the seventh period P7.

When the touch on the touch panel 1100 is again stopped, step S400 is ended.

In step S500, the touch panel driver 1200 determines that the stylus pen 200 or 400 has been spaced apart from the touch panel 1100.

In step S600, the touch panel driver 1200 may sense a period in which the touch on the touch panel 1100 is again stopped.

Referring to FIG. 10, the touch is stopped during the third period P3, is performed during the fourth period P4, is again stopped during the fifth period P5, and is performed during the sixth period P6. The period in which the touch is again stopped may correspond to the duration of the fifth period P5. The touch panel driver 1200 may calculate the duration of the fifth period P5. In addition, the touch is stopped during the seventh period P7, is performed during the eighth period P8, is again stopped during the ninth period P9, and is performed during the tenth period P10. The period in which the touch is again stopped may correspond to the duration of the ninth period P9. The touch panel driver 1200 may calculate the duration of the ninth period P9.

In step S700, the touch panel driver 1200 compares the period in which the touch is again stopped with the first preset range. The duration of the fifth period P5 is compared with the first preset range, and the duration of the ninth period P9 is compared with the first preset range.

When the period in which the touch is again stopped is within the first preset range, step S800 is performed. When the period in which the touch is again stopped is not within the first preset range, step S500 is performed. When the period in which the touch is again stopped exceeds the upper limit of the first preset range, step S500 may be performed even when the period in which the touch is again stopped is not defined.

In step S800, the touch panel driver 1200 compares the period in which the touch is stopped and then is again stopped with the second preset range different from the first preset range. Referring to FIG. 10, the touch is stopped during the third period P3, is performed during the fourth period P4, is again stopped during the fifth period P5, and is performed during the sixth period P6. The period in which the touch is stopped and then is again stopped may correspond to the duration of the fourth period P4. In addition, the touch is stopped during the seventh period P7, is performed during the eighth period P8, is again stopped during the ninth period P9, and is performed during the tenth period P10. The period in which the touch is stopped and then is again stopped may correspond to the duration of the eighth period P8.

When the period in which the touch is stopped and then is again stopped is within the second preset range, step S900 is performed. When the period in which the touch is stopped and then is again stopped is not within the second preset range, step S1000 is performed.

In step S900, the touch panel driver 1200 determines that the second input operation of the stylus pen 200 or 400 has been performed. In the description with reference to FIG. 10, it has been assumed that the duration of the eighth period P8 is within the second preset range. Therefore, the touch panel driver 1200 may determine that the second input operation of the stylus pen 200 or 400 has been performed during the seventh and ninth periods P7 and P9. In this case, it may be neglected that it is determined in step S400 that the first input operation of the stylus pen 200 or 400 has been performed during the seventh period P7.

In step S1000, the touch panel driver 1200 determines that a first function performed by the user at the position in the touch panel 1100, at which the stylus pen 200 or 400 is touched, has been released. In the description with reference to FIG. 10, it has been assumed that the duration of the third period P3 is within the first present range, and the duration of the fourth period P4 is not within the second preset range. Also, in step S400, the touch panel driver 1200 determines that the first function performed by the user has been input during the third period P3. Therefore, in step S1000, the touch panel driver 1200 may determine that the first input operation of the stylus pen 200 or 400 has been released during the fifth period P5.

According to the present disclosure, it is possible to provide a stylus pen that has a simple structure and inexpensive unit cost, and allows a touch sensor to recognize an operation in which an external force is applied to a button or pen tip of the stylus pen, releasing of the operation in which the external force is applied to the button or pen tip of the stylus pen, and a click operation of the button or pen tip of the stylus pen.

Further, according to the present disclosure, it is possible to provide a touch sensor that recognizes an operation in which an external force is applied to a button or pen tip of a stylus pen, releasing of the operation in which the external force is applied to the button or pen tip of the stylus pen, and a click operation of the button or pen tip of the stylus pen, and a driving method of the touch sensor.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims.

What is claimed is:

1. A stylus pen comprising:
a conductor;
a housing surrounding at least one portion of the conductor, the housing having an insulating property;
a pen tip disposed at one end of the housing, the pen tip being conductive; and
a contact member in contact with at least one of the conductor and the pen tip,
wherein the contact member is configured to electrically short or open the conductor and the pen tip.

2. The stylus pen of claim 1, wherein the conductor includes a first terminal that faces the pen tip,
wherein the pen tip includes a second terminal that faces the conductor, and
wherein the contact member includes a switch disposed between the conductor and the pen tip.

3. The stylus pen of claim 2, wherein the pen tip further includes a third terminal that faces the conductor.

4. The stylus pen of claim 3, wherein the switch includes:
a connection conductor connected to the first terminal;
a button configured to move at least one portion of the connection conductor when an external force is applied thereto; and
an elastic member disposed between the connection conductor and the housing,
wherein the connection conductor is disposed between the button and the elastic member,
wherein connection conductor is configured to electrically short the conductor and the pen tip when the connection conductor is in contact with the second terminal or the third terminal,
wherein the connection conductor is configured to electrically open the conductor and the pen tip when the connection conductor is not in contact with the second terminal and the third terminal, and
wherein the connection conductor is configured to be in contact with the second terminal when the external force is not applied to the button for a preset time or more.

5. The stylus pen of claim 1, wherein the conductor includes a body and a first terminal connected to the body, the first terminal facing the pen tip,
wherein the pen tip is connected to the housing to be movable in the housing,
wherein the pen tip includes a second terminal that faces the conductor, and
wherein the contact member includes an elastic member in contact with the pen tip, the elastic member surrounding at least one portion of the pen tip.

6. The stylus pen of claim 5, wherein the first terminal includes:
a first extension part extending in a direction toward the pen tip from the body; and
a first contact part connected to the first extension part to be bent from the first extension part, and
wherein the second terminal includes:
a second extension part extending in a direction toward the conductor from the pen tip; and
a second contact part connected to the second extension part to be bent from the second extension part.

7. The stylus pen of claim 6, wherein the first terminal further includes:
a third contact part connected to the first extension part to be bent from the first extension part; and
a third extension part connecting the third contact part and the body to each other therethrough, the third extension part extending in a direction toward the pen tip from the conductor,
wherein the first extension part connects the third contact part and the first contact part to each other therethrough,
wherein the second part is configured to electrically short the conductor and the pen tip when the second contact part is in contact with the first contact part or the third contact part,
wherein the second part is configured to electrically open the conductor and the pen tip when the second contact part is not in contact with the first contact part and the third contact part, and
wherein the second contact part is configured to be in contact with the second contact part when an external force is not applied to the pen tip for a preset time or more.

8. A touch sensor comprising:
a touch panel including a substrate and electrodes including electrodes arranged on a substrate; and
a touch panel driver configured to determine at least one of whether a stylus pen has been touched on the touch panel, a position in the touch panel on which the stylus pen is touched, and whether at least one of input operations of the stylus pens has been performed or released, the touch panel driver configured to transmit touch information signal including a determined result to the outside,
wherein the touch panel driver is configured to determine that a first input operation among the input operations has been performed during the second period when the stylus pen is touched at a specific position in the touch panel during a first period, is not touched at the specific position during a second period after the first period, and is touched at the specific position during a third period after the second period, and a duration of the second period within a first preset range.

9. The touch sensor of claim 8, wherein the electrodes include:
driving electrodes configured to receive a driving signal from the touch panel driver; and
sensing electrodes configured to transmit a sensing signal to the touch panel driver,
wherein the touch panel driver includes:
a driving signal generator configured to generate the driving signal;
an interface configured to receive the sensing signal;
an analog-digital converter configured to convert the signal received by the interface into a digital signal; and
a digital signal processor configured to determine, based on the digital signal, at least one of whether the stylus pen has been touched on the touch panel, a position in the touch panel on which the stylus pen is touched, and whether an external force has been applied to the stylus pen.

10. The touch sensor of claim 8, wherein the touch panel driver is configured to determine that a second operation among the input operations of the stylus pen has been performed during the second period and the fourth period when the specific position is not touched during a fourth period after the third period and is touched during a fifth period after the fourth period, a duration of the third period is within a second preset range different from the first preset range, and a duration of the fourth period is within the first preset range.

11. The touch sensor of claim 10, wherein the first input operation is an operation of applying an external force to a button of the stylus pen or an operation of applying an external force to a pen tip of the stylus, and
wherein the second input operation is an operation of clicking the button or an operation of clicking the pen tip.

12. The touch sensor of claim 8, wherein the touch panel driver is configured to determine that the first input operation of the stylus pen has been released during the fourth period when the specific position is not touched during a fourth period after the third period and is touched during a fifth period after the fourth period, a duration period of the third period is not within the second preset range, and a duration of the fourth period is within the first preset range.

13. A method for operating a touch sensor, the method comprising:
when a stylus pen is touched on a touch panel, sensing a position in the touch panel on which the stylus pen is touched until the touch is stopped;
calculating a period in which the touch is stopped; and
when the period in which the touch is stopped is within a first preset range, determining that a first input operation of the stylus pen has been performed.

14. The method of claim 13, wherein, in the determining that the first input operation of the stylus pen has been performed, the touched position until the touch is again stopped.

15. The method of claim 14, further comprising, after the determining that the first input operation of the stylus pen has been performed, calculating a period in which the touch is again stopped.

16. The method of claim 15, wherein, in the calculating of the period in which the touch is again stopped, a period in which the touch is stopped and then is again stopped is further calculated, and
wherein the method further comprises, when the period in which the touch is again stopped is included in the first preset range, and the period in which the touch is stopped and then is again stopped is within a second preset range different from the first preset range, determining that a second input operation of the stylus pen has been performed.

17. The method of claim 16, wherein the first input operation is an operation of applying an external force to a button of the stylus pen or an operation of applying an external force to a pen tip of the stylus, and
wherein the second input operation is an operation of clicking the button or an operation of clicking the pen tip.

18. The method of claim 15, wherein, in the calculating of the period in which the touch is again stopped, a period in which the touch is stopped and then is again stopped is further calculated, and
wherein the method further comprises, when the period in which the touch is again stopped is within the first preset range, and the period in which the touch is stopped and then is again stopped is not within the second preset range different from the first preset range, determining that the first input operation of the stylus pen has been released.

19. The method of claim 15, further comprising, when the period in which the touch is again stopped is not within the first preset range, determining that the stylus pen has been spaced apart from the touch panel.
